(19) United States
(12) Patent Application Publication
(10) Pub. No.: US 2018/0269648 A1
(43) Pub. Date: Sep. 20, 2018

(54) Generation of arbitrary time-space distribution phase-coherent discretized laser beams

(71) Applicant: The Board of Trustees of the Leland Stanford Junior University, Palo Alto, CA (US)

(72) Inventors: Joseph Stephen Robinson, San Jose, CA (US); Alan Fry, San Jose, CA (US); Sergio Carbajo, Menlo Park, CA (US); Wei Liu, Palo Alto, CA (US)

(21) Appl. No.: 15/925,014

(22) Filed: Mar. 19, 2018

Related U.S. Application Data
(60) Provisional application No. 62/473,440, filed on Mar. 19, 2017.

(51) Int. Cl. H01S 3/23; H01S 3/10; G02B 27/10

(52) U.S. Cl. CPC H01S 3/23; G02B 27/1006; H01S 3/10053; H01S 3/10061

(57) ABSTRACT

Composite optical beams are formed by placing the outputs of several independently controlled beam lines in a close packed array in an output aperture. Each beam line has at least its phase and polarization under automatic control. Further properties of the beam lines that can optionally be under control include time delay (for pulsed systems), intensity, and nonlinear conversion. The optical inputs to the beam lines are coherent, which can be achieved by splitting the output of a single optical source, or by phase locking two or more distinct optical sources to each other.

### CROSS REFERENCE TO RELATED APPLICATIONS

This application claims the benefit of U.S. provisional patent application 62/473,440, filed on Mar. 19, 2017, and hereby incorporated by reference in its entirety.

### GOVERNMENT SPONSORSHIP

This invention was made with Government support under contract DE-AC02-765F00515 awarded by the Department of Energy. The Government has certain rights in the invention.

### FIELD OF THE INVENTION

This invention relates to optical beam forming.

### BACKGROUND

Various methods have been considered for providing improved control or properties of optical beams relative to what is readily available from optical sources. One approach is often referred to as coherent beam combining, where the goal is to combine the outputs of several optical emitters into a single spatial mode. This is often desirable in applications where high brightness is needed, since single mode operation is required to maximize brightness.

Another approach is the use of a spatial light modulator to provide pixel-by-pixel control of beam properties. Usually this is intensity control. Spatial light modulators tend to be unsuitable for high power applications, and it would be desirable to provide control of more beam parameters than just intensity.

A third approach that has been considered is optical phased arrays. Here several optical emitters have their relative phases controlled in order to enable applications like beam steering. Here also it would be desirable to go beyond what is possible with only phase control.

### SUMMARY

This work relates to the generation of laser beams capable of exhibiting any arbitrary spatio-temporal distribution, including transverse and longitudinal spectral amplitude, transverse and longitudinal phase, transverse polarization distribution, transverse intensity distribution, wave-front, pulse-front, and spectral content.

This approach is based on an array of coherently combined fibers, waveguides or other beam delivery methods (henceforth referred to as “beam line”). In one example, each beam line contains carrier-envelope-stable ultrafast pulses with controlled spectral amplitude, phase, timing, and polarization vector—driven by a common front-end. The underlying rationale is that the ability to control the spectral amplitude, phase, timing, and polarization of each individual beam line provides the means to create customized discretized laser beams with arbitrary spatio-temporal distribution. In practice, the technique would enable the synthesis of laser beams capable of exhibiting non-conventional beam properties, including wavelength, wave-front, pulse-front, phase, transverse shape, and polarization distribution, among others. Beam properties can be programmable in arbitrary and/or complex patterns.

The wide use of lasers in modern science and technology makes this work: (1) an ubiquitous and distinctly increased capability to existing photon source applications; and (2) an enabling capability to new non-existing photon source applications. The following are some examples of areas of applications in both broad categories:

Increased capability for existing photon source applications includes: Spectroscopy; Photochemistry; Lidar technology; Laser scanning; Laser printing; Laser cooling; Microscopy and super-resolution; Nanomaterials; Optical tweezers and trapping; Material processing; Nano- and micro-fabrication; Semiconductor processing; Optical communications; Medical and radiation devices; and Telecom/mode-division multiplexing.

New enabling capability for non-existing photon source applications includes: High energy physics; Military and national security laser sources; Atmospheric propagation; Non-linear optics; Charged-particle beam control and manipulation; Gamma and x-ray radiation; Accelerator technology; Radiation and surgical medical devices; New laser-matter interactions and novel states of matter; and Space propulsion sources.

With respect to the above-described beam lines, their polarization, relative phase and relative timing are controlled for pulsed applications. Beam lines for CW applications have their polarization and relative phase controlled. Here, timing refers to the relative delay between the pulse intensity envelope of each beam line with respect to the other. Phase refers to the electric field phase offset of each beam line with respect to others regardless of their relative delay (timing). In the case of CW systems, only the relative phase delay is to be defined because there is no such intensity envelope as defined for pulsed systems.

For both pulsed and CW applications, the beam lines can optionally further include control of intensity and/or nonlinear conversion. Intensity control can provide control of the transverse distribution of the beam intensity, and nonlinear conversion can be useful for hyper-spectral beam generation.

This approach combines two key capabilities in photonics technology:

1) Programmable spatio-temporal amplitude, phase, polarization distribution, and
2) Phase-locked pulse synthesis of fiber arrays.

Significant advantages are provided. Power scaling is easier by amplifying individual lines prior to combination. There is no inherent limitation on the number of beam lines used to form the composite beam.

Spatial light modulators (SLM) only address intensity variation across parts of a beam. Compared to SLM performance, the present approach brings a solution to produce programmable laser fields with:

a) More versatility,
b) Greater parameter range (e.g. nonlinear conversion),
c) More than 3 orders of magnitude higher average power, and
d) More than 12 orders of magnitude higher peak power.

### BRIEF DESCRIPTION OF THE DRAWINGS

FIG. 1 shows a first conceptual embodiment of the invention.

FIG. 2 shows a second conceptual embodiment of the invention.

FIG. 3 shows a first exemplary embodiment of the invention.

FIG. 4 shows a second exemplary embodiment of the invention.

FIG. 5 shows exemplary output polarization patterns that can be provided by embodiments of the invention.

FIGS. 6A-D show exemplary output intensity patterns that can be provided by embodiments of the invention.

FIGS. 6E-H show further exemplary output polarization patterns that can be provided by embodiments of the invention.

FIGS. 6I-L show exemplary output phase patterns that can be provided by embodiments of the invention.

FIGS. 7A-F show modeled results for beam propagation of a composite beam having a dark center.

FIG. 8 shows a third exemplary embodiment of the invention.

FIG. 9 shows an exemplary approach for providing control of beam line optical parameters.

FIGS. 10A-D show several options for providing a composite beam from the several beam lines.

### DETAILED DESCRIPTION

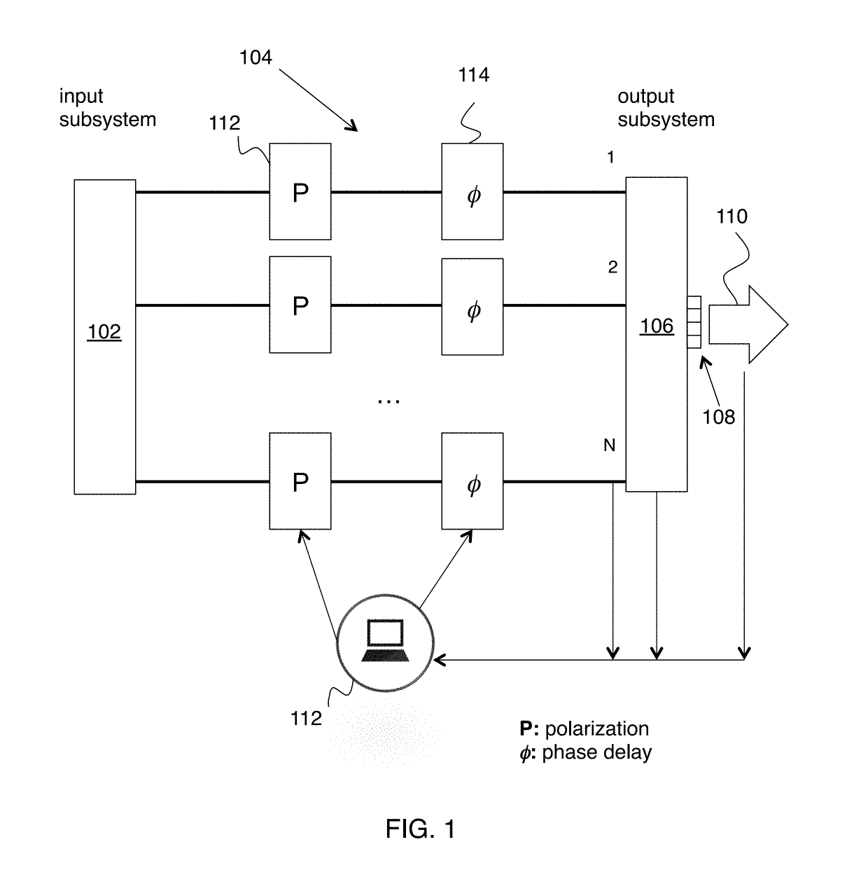

FIG. 1 shows a first conceptual embodiment of the invention. In this example, the apparatus includes two or more optical beam lines 104 where at least phase and polarization of outputs of each of the beam lines is independently under automatic control. Beam lines 104 can be implemented in waveguides, fiber optics and/or in free space optics. Here the polarization and phase control is schematically shown with “P” and “ϕ” blocks respectively. The polarization control and phase control for beam line 1 are referenced as 112 and 114 respectively. An input optical subsystem 102 provides phase coherent optical inputs to each of the optical beam lines. An output optical subsystem 106 receives the outputs of each of the beam lines and provides a composite output 110 at an emission aperture 108. Emission aperture 108 includes an optical emitter corresponding to each of the optical beam lines, as seen more clearly in the detailed examples described below. The optical emitters are configured as a close-packed array of emitters.

A control system 112 is configured to provide the automatic control of the beam lines, where control inputs to the control system include at least samples of the composite output 110, and where control outputs of the control system 112 include control signals applied to optical components of the beam lines. Control inputs may optionally further include measurements from inputs to output optical subsystem 106 and/or measurements from within output optical subsystem 106, as schematically indicated by the arrows on FIG. 1 leading to control system 112.

Here optical radiation is defined as having a free space wavelength in a range from 150 nm to 50 μm. This covers the ultraviolet, visible and infrared parts of the electromagnetic spectrum. In this range of the electromagnetic spectrum, control of beam parameters such as phase, polarization, etc. can generally be accomplished using readily available components according to principles known to art workers.

A ‘composite output’ of an optical system is defined as an optical output where different beam lines correspond to different parts of the output aperture. The output aperture can be regarded as an array, usually close-packed, of individual emitters. A close-packed array of emitters has emitters that are physically contiguous and which exhibit similar optical and mechanical characteristics. Here each individual emitter corresponds to one of the beam lines. The propagation direction of all emitters is substantially the same (i.e., to within +/−10 degrees). The resulting optical emission is conveniently referred to as a composite laser beam, because its near-field has distinct parts corresponding to each of the optical emitters, but there will be overlap and interference of these parts in the far field to create a single composite beam. Preferably the size of the output aperture is 5λ or greater, where λ is the free-space wavelength.

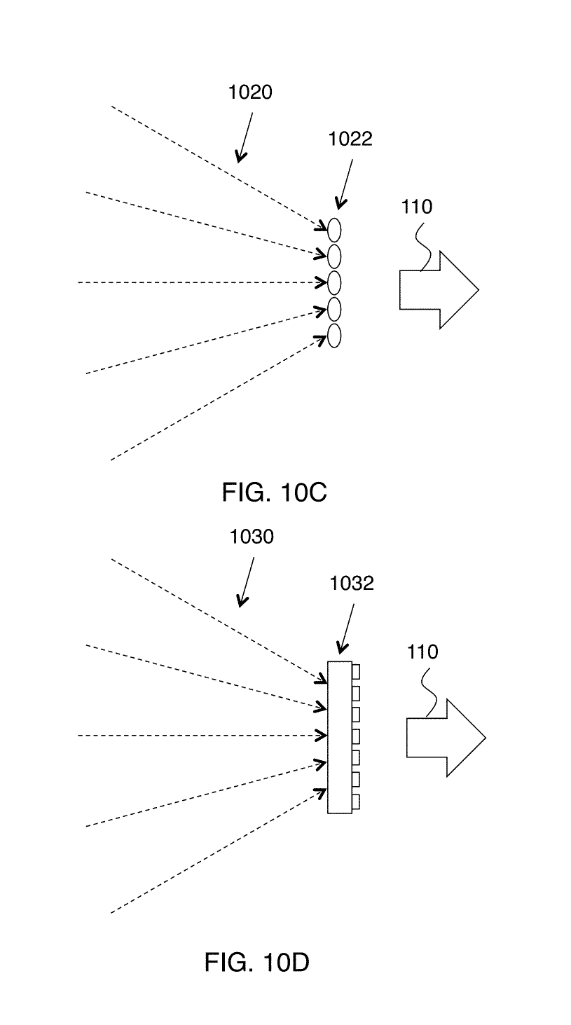

Output apertures of this kind can be realized in various ways, including diffractive optics, lens arrays, arrays of optical fibers, and multi-core fiber optic structures, as described below in connection with FIGS. 10A-D. The main requirement on any such optical output subsystem is to provide the beam line outputs to the output aperture faithfully so that the control of beam line parameters has corresponding effects on the parts of the composite beam output from each beam line.

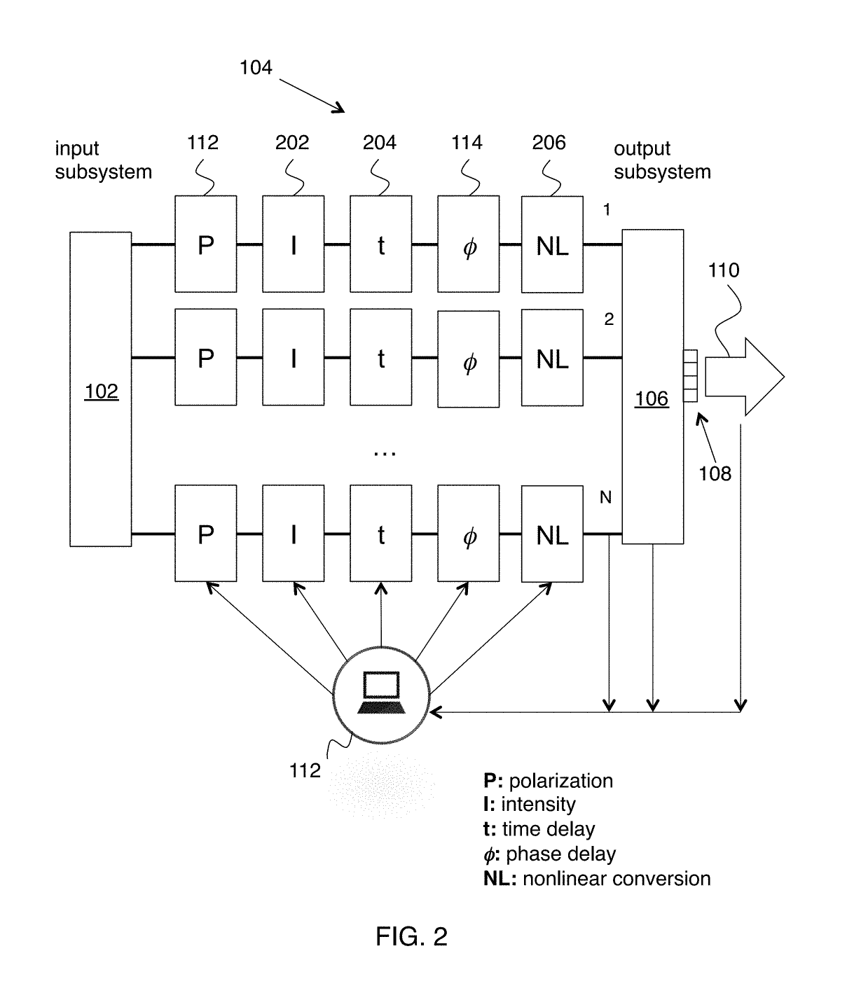

FIG. 2 shows a second conceptual embodiment of the invention. This example is similar to the example of FIG. 1, except that here each beam line has polarization, intensity, time delay, and phase under automatic control. Furthermore, beam lines 104 on FIG. 2 are nonlinear beam lines that include a nonlinear frequency conversion unit. The outputs of the nonlinear beam lines are at one or more output frequencies distinct from input frequencies at inputs of the nonlinear beam lines. Here the polarization, intensity, time delay and phase control is schematically shown with “P”, “I”, “t” and “ϕ” blocks respectively. Nonlinear frequency conversion units blocks are labeled as “NL”. In beam line 1, the polarization, intensity, time delay, phase and nonlinear conversion blocks are referenced as 112, 202, 204, 114, and 206 respectively.

In other embodiments, any combination or all of intensity control, time delay control and nonlinear conversion can be added to the basic phase and polarization control scheme of FIG. 1. Embodiments can be continuous wave (CW) systems or pulsed systems, and time delay is typically only a relevant parameter for pulsed systems where the relative timing of pulses is important.

Practice of the invention does not depend critically on how the functions of polarization control, phase control and optional features such as intensity control, time delay control and/or nonlinear conversion are implemented.

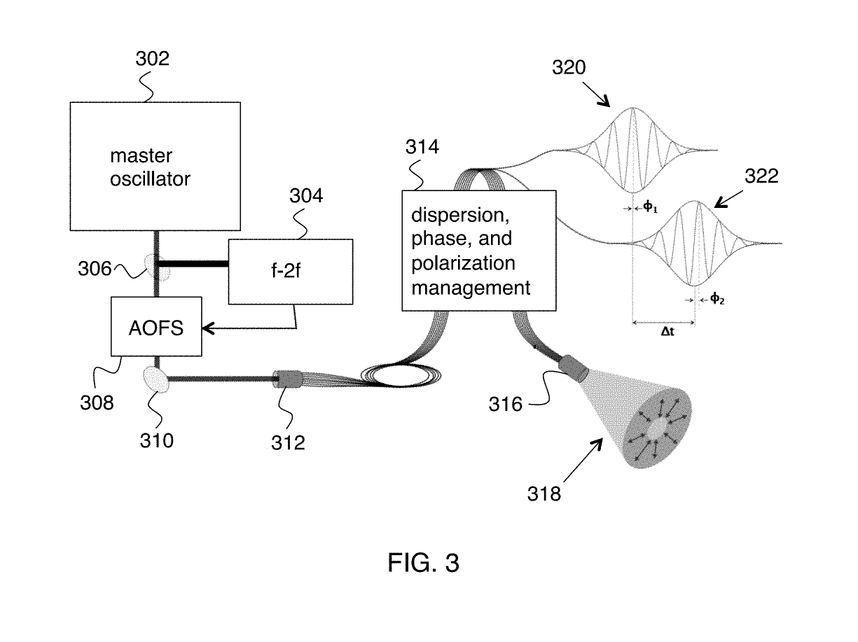

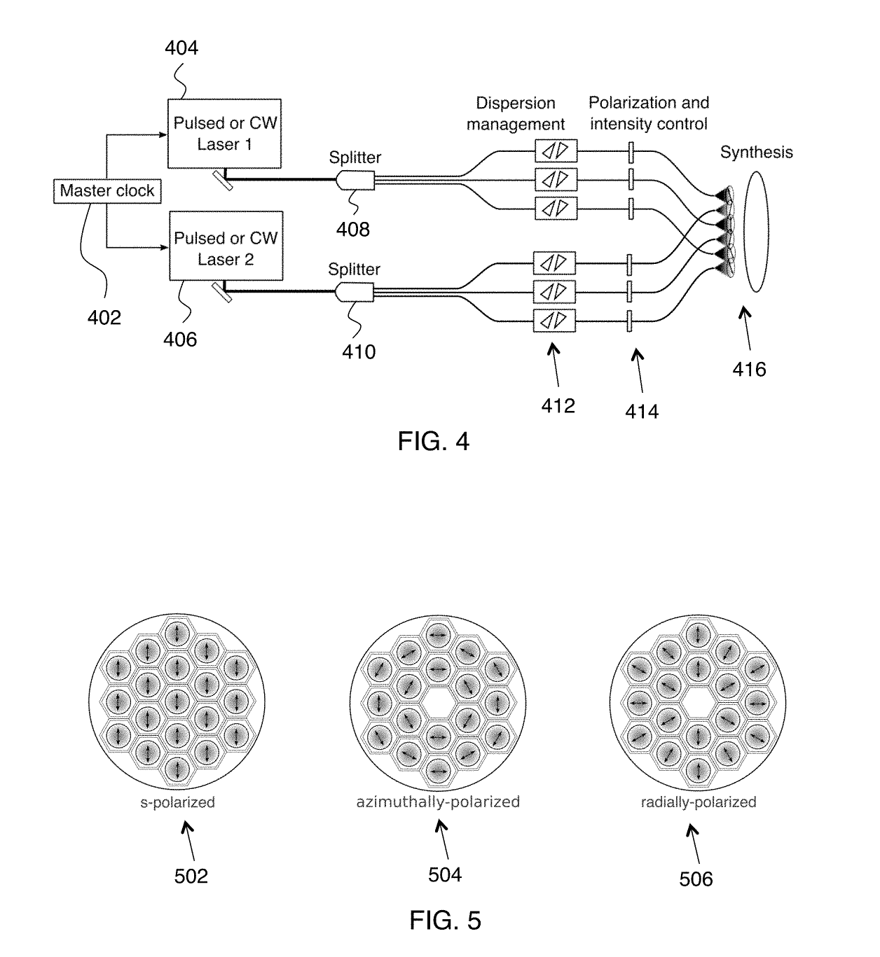

There are numerous ways for the input optical subsystem to provide phase coherent optical inputs to each of the optical beam lines, and the present invention can be practiced in connection with any of these ways. The two main categories of suitable input optical subsystems are: 1) the input optical subsystem includes a single master laser source connected to an optical splitter, and 2) the input optical subsystem includes two or more laser sources that are made phase coherent with respect to each other with a control system. The examples of FIGS. 3 and 4 relate to the first and second categories, respectively.

FIG. 3 shows a first exemplary embodiment of the invention. This is a single or few-cycle CEP-locked master source split N ways in fiber with individual dispersion, phase and polarization management. Here a master oscillator 302 is under carrier-envelope-phase (CEP) locking and stabilization using a feed-forward scheme. Briefly, an f−2f interferometer 304 provides a modulation signal at f_{ref}+f_{CEO} to an acoustic optic frequency shifter (AOFS) 308. Here CEO is short for Carrier-Envelope Offset. Tap 306 provides the optical input to interferometer 304. Master oscillator 302 in this example is a femtosecond SESAM mode-locked laser operating at a wavelength of 1.5 microns. Here SESAM is short for SEmiconductor Saturable Absorber Mirror.

The output of AOFS 308 is delivered in free space by mirror 310, and is then fiber coupled and split by fiber splitter 312. In each fiber, dispersion, phase and polarization are individually controlled in unit 314. Dispersion can be controlled via isochronic prisms and monitored via linear interferometry and/or optical heterodyne detection. Polarization can be managed by solid-state waveplates or fiber based techniques exploiting optical fiber birefringence.

Output aperture 316 forms the composite beam 318, as schematically shown. The composite beam can be formed via microlens array focusing or high fill-factor multi-core monolithic fiber structure.

This figure also shows the significance of the time delay and phase parameters in a pulsed system. Here the time delay Δt of two pulses is defined with respect to their envelopes as shown on pulses 320 and 322. The phase within each pulse can be defined relative to a reference feature of the pulse envelopes. Here this reference feature is the maximum of the pulse envelope, as shown on pulses 320 and 322.

FIG. 4 shows a second exemplary embodiment of the invention. This is a 4D dual-spectrum pulse synthesis of independently polarization-, phase-, and intensity-controlled beam lines from two synchronized high-power laser sources. Here lasers 404 and 406 are made phase coherent with respect to each other in a control system having a master clock 402. Lasers 404 and 406 can be at the same wavelength or at different wavelengths. If they are at different wavelengths, then master clock 402 is taken to include a suitable reference for the wavelength difference of lasers 404 and 406. Carrier-envelope phase (CEP) locking is not required in this example. Synchronization of the two laser sources can be achieved with a master RF clock via phase-locked loop detection.

The outputs of lasers 404 and 406 are split in fiber splitters 408 and 410 respectively, and then each fiber has individual dispersion management 412 (here taken to include phase control) and individual polarization and intensity control 414. Dispersion and phase can be controlled via optical delay line modules if the system is CW or with isochronic prisms if the system is pulsed. Polarization can be managed by polarization-maintaining fiber arrays after the dispersion management stage.

The composite output beam is formed by output aperture 416. The discretized synthesized beam can be formed via diffractive optics.

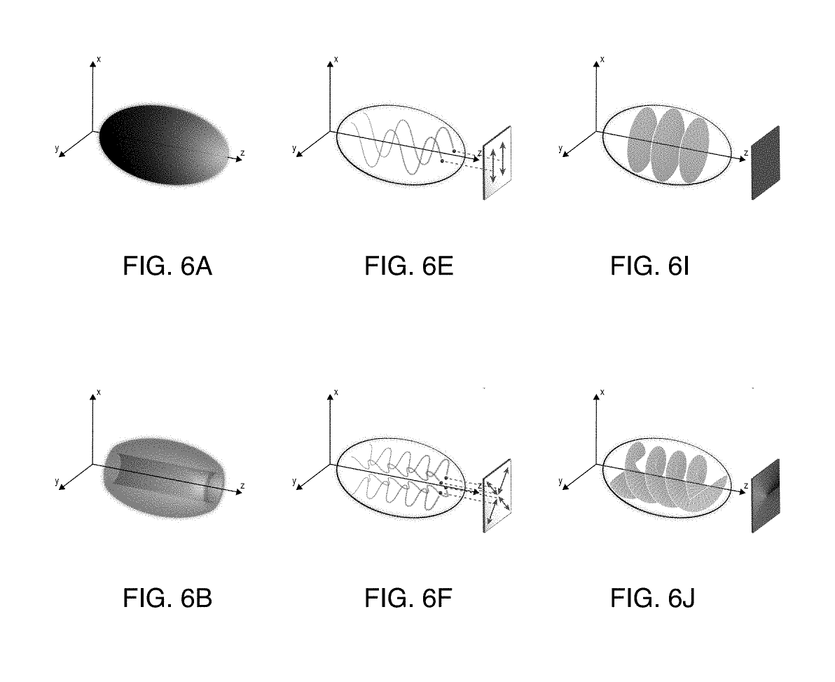

As indicated above, embodiments of the invention advantageously provide a high degree of flexibility for optical beam forming. Polarization is an especially compelling example, as seen in FIG. 5. This figure shows exemplary output polarization patterns that can be provided by embodiments of the invention. 502 on FIG. 5 shows each part of the composite output beam having the same linear polarization direction. 504 on FIG. 5 shows parts of the composite output beam having different polarizations such that the overall polarization pattern is azimuthal. 506 on FIG. 5 shows parts of the composite output beam having different polarizations such that the overall polarization pattern is radial. Optical beams having radial or azimuthal polarization are not naturally provided by typical optical emitter structures, so this novel feature of significant polarization flexibility in composite beams is a substantial advance in the art.

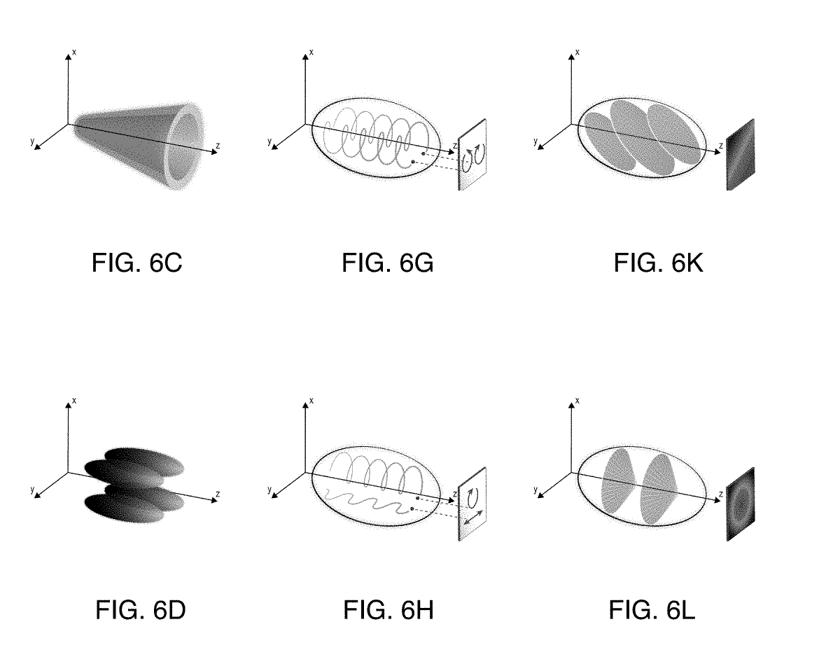

Further examples of the extraordinary flexibility of composite beams according to these principles are shown on FIGS. 6A-L. FIGS. 6A-D, 6E-H, and 6I-L relate to intensity patterns, polarization patterns and phase patterns, respectively.

FIGS. 6A-D show exemplary output intensity patterns that can be provided by embodiments of the invention. FIG. 6A is a single-lobed beam. FIG. 6B is a beam with a hollow center (i.e., dark on-axis or having a relative intensity minimum on-axis). FIG. 6C is a beam configured to have a cone-like intensity profile. FIG. 6D is a beam configured to have multiple intensity lobes.

FIGS. 6E-H show further exemplary output polarization patterns that can be provided by embodiments of the invention. FIG. 6E is an example of linear polarization. FIG. 6F is an example of radial polarization. FIG. 6G is an example of two parts of the beam having two different senses of circular polarization. FIG. 6H is an example of one part of the beam having linear polarization and another part of the beam having circular polarization.

FIGS. 6I-L show exemplary output phase patterns that can be provided by embodiments of the invention. FIG. 6I shows flat phase fronts perpendicular to the propagation direction. FIG. 6J shows phase fronts having a spiral pattern in propagation. FIG. 6K show flat tilted phase fronts. FIG. 6L shows phase fronts having a conical pattern in propagation.

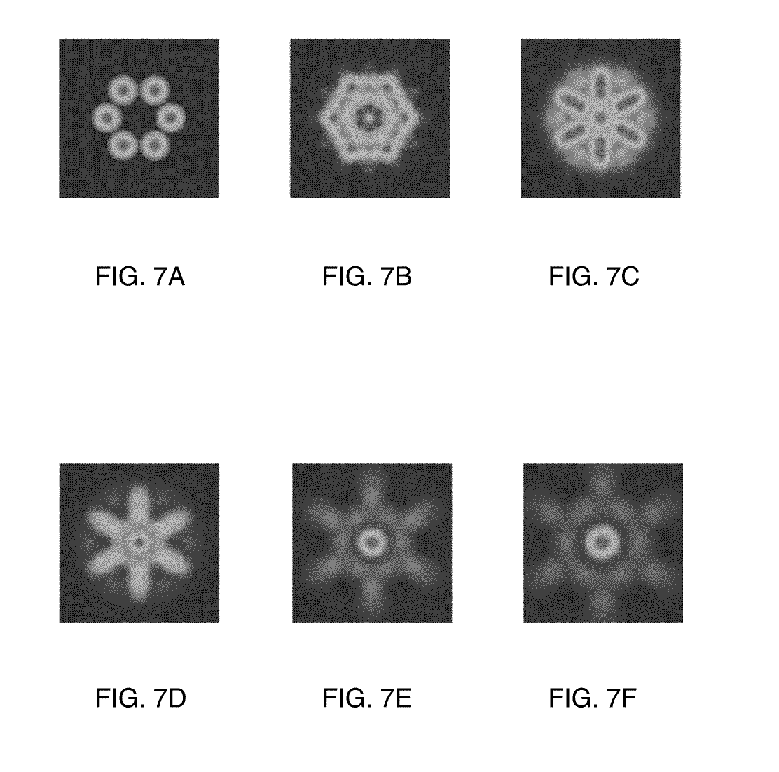

Propagation of composite optical beams can lead to interesting results. For example, FIGS. 7A-F show modeled results for beam propagation of a composite beam having a dark center. Here FIG. 7A is the composite beam emission pattern from the output aperture, and propagation distance increases for FIGS. 7B, 7C, 7D, 7E, and 7F in sequence.

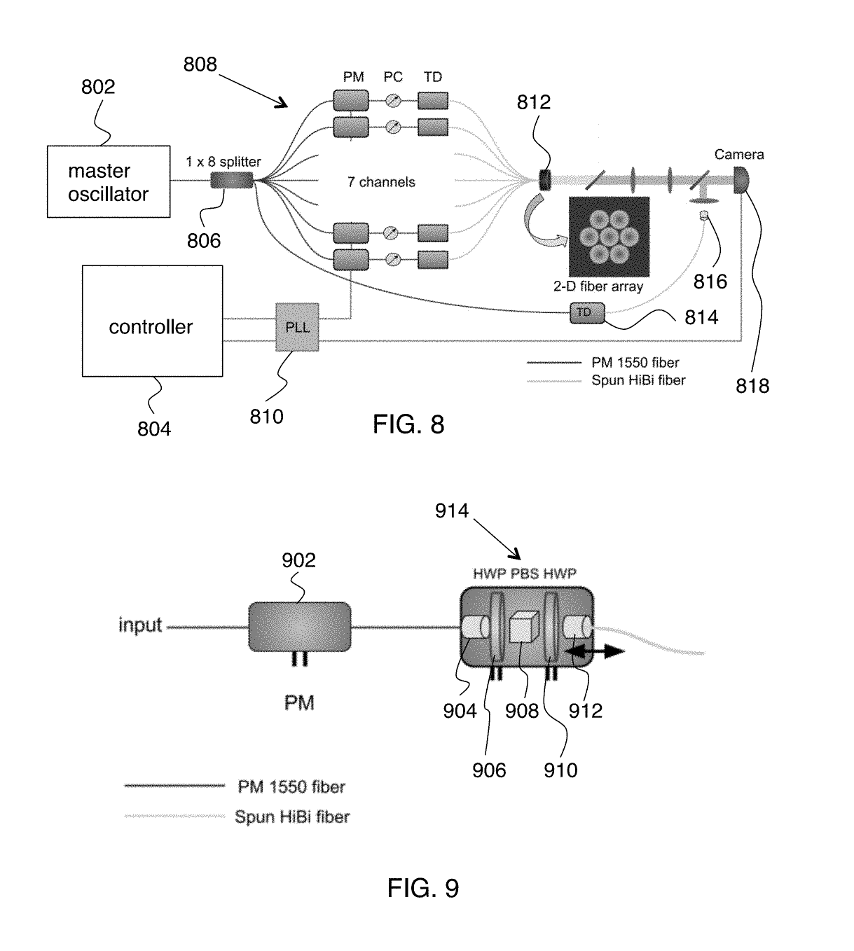

FIG. 8 shows a third exemplary embodiment of the invention. Here the output from master oscillator 802 is split 8 ways in 1×8 fiber splitter 806. Seven of these channels are beam lines 808, and have their phase (PM), polarization (PC) and time delay (TD) controlled as schematically shown. Output aperture 812 forms a composite beam as shown. Controller 804 and phase locked loop (PLL) 810 control the system based on measurements from camera 818. The eighth output from splitter 806 is passed through time delay 814, is emitted from aperture 816 and is combined with the main composite beam to provide a reference for camera 818. In this example, it was found that the phase of each fiber channel needed to be controlled to within λ/10 or better to keep a combining efficiency above 95% of its theoretical maximum value.

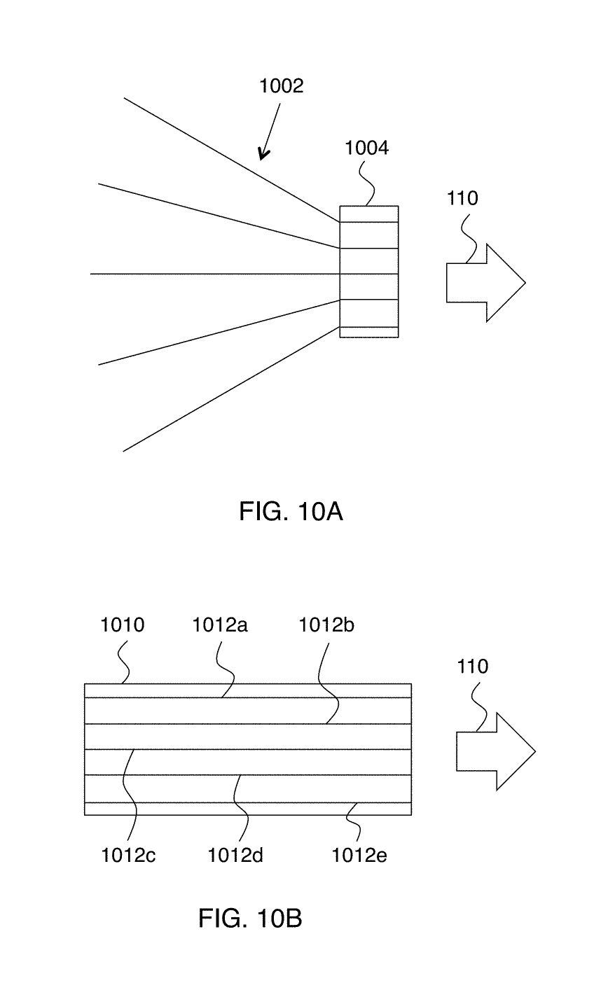

FIG. 9 shows an exemplary approach for providing control of beam line optical parameters. In this example, the optical input passes through phase modulator 902 (PM) and then passes through time delay, intensity and polarization (TIP) control unit 914. TIP control unit 914 includes a fiber to free space coupler 904, a free space half-wave plate 906, a free-space polarizing beam splitter 908, a free space half-wave plate 910, and a free-space to fiber coupler 912. Control of half-wave plates 906 and 910 in this arrangement can provide polarization and intensity control according to known principles. Longitudinal motion of free-space to fiber coupler 912, as shown, can provide time delay control according to known principles.

In the example of FIGS. 7-8, the output fibers are spun HiBi fiber having circular birefringence as opposed to conventional polarization-maintaining fiber having linear birefringence, as shown on the figures. Spun optical fibers are manufactured by spinning a bowtie-style, single mode, and polarization-maintaining preform during the draw process as opposed to twisting it after drawing. They are spun so that the bowtie rotates along the axial direction of the fiber. Unlike traditional polarization-maintaining fibers, they are designed to preserve linear and circular polarization, and the output polarization is insensitive to thermal and vibrational noise, as well as drift caused by stress-induced birefringence.

As indicated in the preceding examples, there are various ways to form a composite beam 110 in embodiments of the invention. Practice of the invention does not depend critically on how this is done. Suitable output optical subsystems include, but are not limited to: a close-packed array of optical fibers, a monolithic multi-core optical fiber structure, a lens array, and a diffractive optical structure. FIGS. 10A-D show these options.

The example of FIG. 10A relates to a close-packed array of optical fibers. In this side view, fibers 1002 fan-in to a ferrule 1004 that holds the fibers in a close-packed arrangement to form the output aperture for composite beam 110. Corresponding end-views are shown in prior examples.

The example of FIG. 10B relates to a monolithic multi-core optical fiber structure. Here a fiber cladding matrix 1010 includes several cores (1012a, 1012b, 1012c, 1012d, 1012e). The cores can be arranged to provide the desired pattern of the output aperture for composite beam 110.

The example of FIG. 10C relates to a lens array. Here optical beams 1020 (in fibers, waveguides or in free space) are received by a lens array 1022 to form the output aperture for composite beam 110.

The example of FIG. 10D relates to a diffractive optical structure. Here optical beams 1030 (in fibers, waveguides or in free space) are received by a diffractive optical structure 1032 to form the output aperture for composite beam 110. One possibility for such a diffractive structure is an array of small Fresnel lenses. Other suitable diffractive optical structures can be designed according to known principles to provide suitable output apertures for composite beams in embodiments of the invention.

1. Apparatus for providing a composite laser beam, the apparatus comprising:
two or more optical beam lines, wherein at least phase and polarization of outputs of each of the beam lines is independently under automatic control;
an input optical subsystem that provides phase coherent optical inputs to each of the optical beam lines;
an output optical subsystem that receives the outputs of each of the beam lines and provides a composite output at an emission aperture;
wherein the emission aperture includes an optical emitter corresponding to each of the optical beam lines;
wherein the optical emitters are configured as a close-packed array of emitters;
a control system configured to provide the automatic control of the beam lines, wherein control inputs to the control system include at least samples of the composite output, and wherein control outputs of the control system include control signals applied to optical components of the beam lines.

2. The apparatus of claim 1, wherein intensity of outputs of each of the beam lines is independently under automatic control.

3. The apparatus of claim 1, wherein one or more of the beam lines are nonlinear beam lines that include a nonlinear frequency conversion unit, and wherein the outputs of the nonlinear beam lines are at one or more output frequencies distinct from input frequencies at inputs of the nonlinear beam lines.

4. The apparatus of claim 1, wherein the composite laser beam is a continuous-wave laser beam.

5. The apparatus of claim 1, wherein the composite laser beam is a pulsed laser beam.

6. The apparatus of claim 5, wherein time delay of outputs of each of the beam lines is independently under automatic control.

7. The apparatus of claim 1, wherein the input optical subsystem includes a single master laser source connected to an optical splitter.

8. The apparatus of claim 1, wherein the input optical subsystem includes two or more laser sources that are made phase coherent with respect to each other with a control system.

9. The apparatus of claim 1, wherein the beam lines are implemented in fiber optics.

10. The apparatus of claim 1, wherein the beam lines are implemented in free-space optics.

11. The apparatus of claim 1, wherein the output optical subsystem is selected from the group consisting of: a close-packed array of optical fibers, a monolithic multi-core optical fiber structure, a lens array, and a diffractive optical structure.
